(19) United States
(12) Patent Application Publication
(10) Pub. No.: US 2012/0034332 A1
(43) Pub. Date: Feb. 9, 2012

(54) HOT-RUNNER SYSTEM HAVING BLADDER ASSEMBLY

(75) Inventor: James Osborne Plumton, Enosburg, VT (US)

(73) Assignee: HUSKY INJECTION MOLDING SYSTEMS LTD., Bolton, ON (CA)

(21) Appl. No.: 13/265,861

(22) PCT Filed: May 12, 2010
(86) PCT No.: PCT/US2010/034484

§ 371 Date: Oct. 22, 2011

Related U.S. Application Data
(60) Provisional application No. 61/182,396, filed on May 29, 2009.

(51) Int. Cl. B29C 45/74

(52) U.S. Cl. 425/547

(57) ABSTRACT

A hot-runner system (100), including: a support structure (102); an actuation plate (106) being movable relative to the support structure (102); and a bladder assembly (108) being installed between the actuation plate (106) and the support structure (102). The purpose of the present invention is to provide a means for pneumatically actuating an actuation plate that drives valve pin(s) stroke, opening and closing flow path(s) to a mold assembly.

### TECHNICAL FIELD

Embodiments of the present invention generally relate to hot-runner system used in an injection molding system.

### BACKGROUND OF THE INVENTION

Examples of known molding systems are (amongst others): (i) the HyPET (TRADEMARK) Molding System, (ii) the Quadloc (TRADEMARK) Molding System, (iii) the Hylectric (TRADEMARK) Molding System, and (iv) the HyMet (TRADEMARK) Molding System, all manufactured by Husky Injection Molding Systems Limited (Location: Bolton, Ontario, Canada; www.husky.ca).

### SUMMARY OF THE INVENTION

The invention is set forth and characterized in the main claim(s), while the dependent claims describe other characteristics of the invention.

More and more, customers doing precision molding are calling for “synchronous” valve pin actuation for their valve gated hot runners. The valve pins move together as they are attached to a single plate that moves back and forth. Plate actuated systems are commercially available that use either hydraulics or electric motors to move the plate. While these methods of actuation may work well for some applications, some molding shops may still be best suited for pneumatic plate actuation.

The purpose of the present invention is to provide a means for pneumatically actuating an actuation plate that drives valve pin(s) stroke, opening and closing flow path(s) to a mold assembly. Both hydraulics and electric motors have been used as a means for actuation. Systems with hydraulic actuation use a number of piston assemblies that push or pull the plate. These hydraulic piston assemblies can consume a lot of space in the hot runner, apply uneven loads to the plate (could cause binding) and may also require unwanted maintenance. Systems using an electric motor to actuate the plate typically have belt, gear or ball screw drives that move the plate using some form of cam mechanisms. These systems are costly and can be prone to premature wear/failure.

In sharp contrast, the aspects of the present invention may use an inflatable actuator device (also called a “bladder” or “bladder unit”) to move the actuation plate, which provides a simple, cost effective and robust solution to valve pin plate actuation.

Therefore, a general aspect of the invention is to provide a hot-runner system (100), including: a support structure (102); an actuation plate (106) being movable relative to the support structure (102); and a bladder assembly (108) being installed between the actuation plate (106) and the support structure (102).

These and other aspects and features of non-limiting embodiments of the present invention will now become apparent to those skilled in the art upon review of the following description of specific non-limiting embodiments of the invention in conjunction with the accompanying drawings.

### DETAILED DESCRIPTION OF THE DRAWINGS

The invention and its embodiments will be more fully appreciated by reference to the following detailed description of illustrative (non-limiting) embodiments in accordance with the present invention when taken in conjunction with the accompanying drawings, in which:

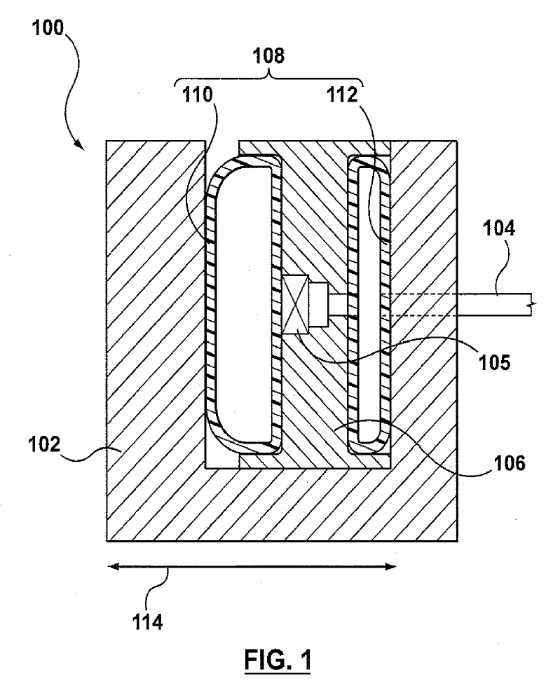

FIG. 1 depicts a schematic representation of a cross section of a hot-runner system 100; and

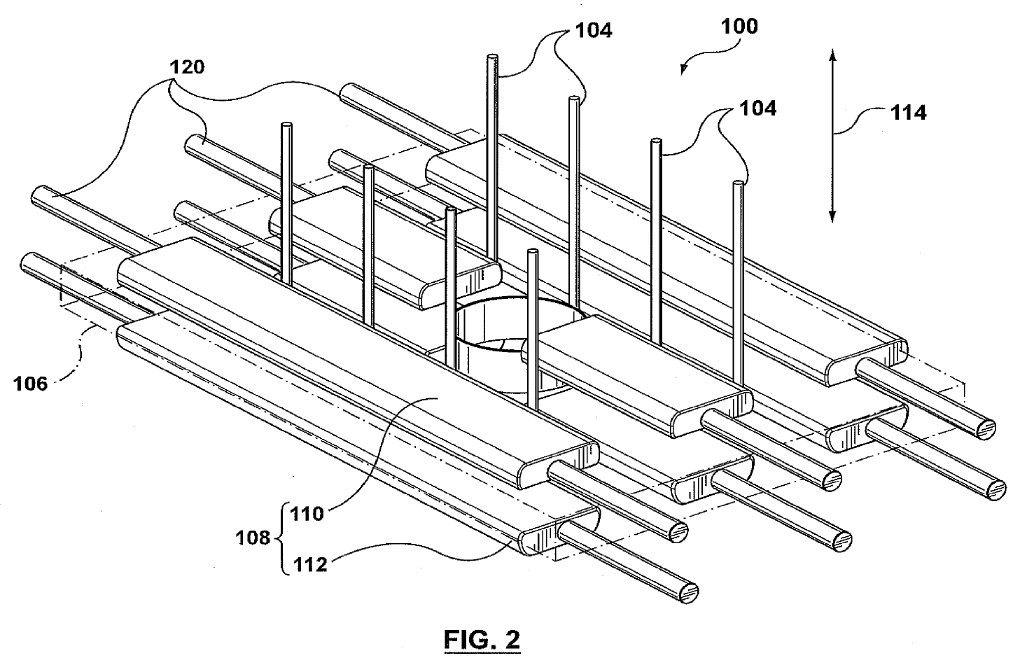

FIG. 2 depicts a perspective view of the hot-runner system 100 of FIG. 1.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION OF THE NON-LIMITING EMBODIMENT(S)

Reference will now be made in detail to the non-limiting embodiment(s) of the present invention. The hot-runner system 100 may include components that are known to persons skilled in the art, and these known components will not be described here; these known components are described, at least in part, in the following reference books, for example: (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Machines” 3rd Edition 3rd Edition authored by JOHANNABER (ISBN 3-446-17733-7) and/or (iv) “Runner and Gating Design Handbook” authored by BEAUMONT (ISBN 1-446-22672-9).

FIG. 1 depicts the schematic representation of the cross section of the hot-runner system 100. The hot-runner system 100 includes (but is not limited to): (i) a support structure 102, (ii) a valve pin 104, (iii) an actuation plate 106, and (iv) a bladder assembly 108. The valve pin 104 is movable relative to the support structure 102. The actuation plate 106 is movable relative to the support structure 102. The actuation plate 106 is connected with the valve pin 104 (via a pin coupler 105). The bladder assembly 108 is installed between the actuation plate 106 and the support structure 102. The bladder assembly 108 includes: (i) a first bladder unit 110 located on a first side of the actuation plate 106 and a second bladder unit 112 located on a second side of the actuation plate 106. The actuation plate 106 is movable along a direction or a stroke 114. To move the valve pin 104 to the valve-closed position, the first bladder unit 110 is inflated with a pressurized fluid (such as, pressurized air, etc) while the second bladder unit 112 is not pressurized, and as a result the first bladder unit 110 becomes inflated and pushes the actuation plate 106 to the right side of FIG. 1 so as to move the valve pin 104 toward the valve-closed position. To move the valve pin 104 to the valve-opened position, the first bladder unit 110 is depressurized while the second bladder unit 112 is pressurized with a fluid, and as a result the first bladder unit 112 becomes inflated and pushes the actuation plate 106 to the left side of FIG. 1 so as to move the valve pin 104 toward the valve-opened position.

The bladder units 110, 112 include a thin, flexible walled pressure vessel that is inflatable with a high-pressure fluid such that the vessel volume expands. The pressure vessel is constrained in such a way as to translate its change in volume to a force applied in an intended direction. The inflatable actuators (also called “pressure vessel”) may be placed on one or both sides of the actuation plate 106, moving the actuation plate 106 back and forth as the pressure vessel(s) are inflated and deflated. This type of actuation system is cost effective and requires very little maintenance. More importantly, since the pressure vessel applies the actuation force over a broad area of the actuation plate 106, the actuation plate 106 and the guidance system of the actuation plate 106 are exposed to more uniform forces, thus leading to less bushing wear and lower potential for plate binding.

It will be appreciated that FIG. 1 appears to show the valve pin 104 passing through the bladder assembly 108, which is not intended. It is preferred that the valve pin 104 does not extend through a bladder unit of the bladder assembly 108. FIG. 1 depicts at least part of the valve pin 104 in phantom lines, and it will be appreciated this is not intended to depict the valve pin 104 as supposedly passing through the middle of the bladder unit 112, but rather there are bladder units 112 is positioned on either side of the valve pin is positioned on either side of the valve pin 104, with the valve pin 104 passing by the bladder units 112 so positioned on either side of the valve pin 104. The configuration as illustrated in FIG. 1 would require either: (i) more than one bladder unit (with the valve pin spaced between the bladder units), or (ii) the valve pin 104 is offset from a single bladder unit 112. It will be appreciated that a number of valve pins 104 may be connected to the actuation plate 106. The bladder units 110, 112 are inflatable and deflatable, and the valve pins 104 may be attached to each side of the actuation plate 106, such that when one bladder is inflated with a high-pressure fluid, the actuation plate 106 is pushed to the opposite side thus moving the valve pins 104 to close the flow path into a mold assembly (not depicted but known). When the second bladder unit 112 is inflated with high pressure fluid and the first bladder unit 110 is deflated, the actuation plate 106 is pushed to the opposite side thus moving the valve pins 104 to open the flow path into the mold assembly.

FIG. 2 depicts a perspective view of the hot-runner system 100 of FIG. 1. It will be appreciated that FIG. 2 appear to depict the rightmost row of valve pins 104 (also called valve stems) terminating in the middle of the lower bladder unit, and it will also be appreciated that the valve pins 104 pass beside the bladder (that is, the pins 104 do not terminate in the lower bladder unit). The portion of the pins 104 depicted as extending below the rightmost row of valve pins 104 is merely the connection of the pins 104 to the actuation plate 106. FIG. 2 depicts an arrangement of bladder units 110, 112 in which two columns with four rows of valve pins 104 are attached to the actuation plate 106, and multiple bladder units 110, 112 are spaced between the valve pins 104. FIG. 2 depicts an example of a configuration with the multiple bladder units, which provides a way to ensure that all the bladder units actuate in synchronization so as not to inadvertently cock the actuation plate 106. It will be appreciated that there will inevitably be slight differences in the inflation of each bladder unit. It is preferred to provide consistent air supply from the hot-runner plates (or the injection-molding system) to each bladder unit. Ideally, there should be no constrictions within the bladder units (thus ensuring good flow), no static friction to overcome or any stick/slip action (thus as there would be on pneumatic or hydraulic pistons). Side walls of the bladder units are designed to be stiff enough such that each bladder unit will fill evenly bearing against the actuation plate 106 with a broad surface area. Although it will likely not be possible to provide absolutely synchronous bladder inflation, it will be significantly better than two point loads applied by pneumatic or hydraulic pistons.

In accordance with another non-limiting embodiment, only one bladder unit 110 is attached to one side of the actuation plate 106. As the bladder unit 110 is inflated, the bladder unit 110 moves the actuation plate 106, opening or closing mold gates with the valve pins 104. When the bladder unit 110 is deflated, the return motion of the actuation plate 106 may be performed by a preloaded spring (not depicted) that is (not depicted) that is coupled to the actuation plate 106. Air hoses 120 connect the bladders 110, 112 to the pressurized fluid.

It is noted that the foregoing has outlined some of the more pertinent non-limiting embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed non-limiting embodiments can be effected without departing from the spirit and scope of the invention. The described non-limiting embodiments ought to be construed to be merely illustrative of some of the more prominent features and applications of the invention. Other beneficial results can be realized by applying the disclosed invention in a different manner or modifying the invention in ways known to those familiar with the art. This includes the mixing and matching of features, elements and/or functions between various non-limiting embodiments is expressly contemplated herein, unless described otherwise, above.

What is claimed is:

1. A hot-runner system (100), comprising:
a support structure (102);
an actuation plate (106) being movable relative to the support structure (102); and
a bladder assembly (108) being installed between the actuation plate (106) and the support structure (102).

2. A hot-runner system (100), comprising:
a support structure (102);
a valve pin (104) being movable relative to the support structure (102);
an actuation plate (106) being movable relative to the support structure (102), the actuation plate (106) being connected with the valve pin (104); and
a bladder assembly (108) being installed between the actuation plate (106) and the support structure (102).

3. The hot-runner system (100) of claim 2, wherein:
the bladder assembly (108) includes:
a first bladder unit (110) located on a first side of the actuation plate (106), and
a second bladder unit (112) located on a second side of the actuation plate (106).

4. The hot-runner system (100) of claim 3, wherein:
the first bladder unit (110) and the second bladder unit (112) include:
a flexible walled pressure vessel that is inflatable with a high-pressure fluid, such that the flexible walled pressure vessel is inflatable and deflatable.

5. The hot-runner system (100) of claim 4, wherein:
the actuation plate (106) is movable along a direction or a stroke (114);
to move the valve pin (104) to a valve-closed position, the first bladder unit (110) is inflated with a pressurized fluid while the second bladder unit (112) is not pressurized, and as a result the first bladder unit (110) becomes inflated and pushes the actuation plate (106), so as to move the valve pin (104) toward the valve-closed position; and
to move the valve pin (104) to a valve-opened position, the first bladder unit (110) is depressurized while the second bladder unit (112) is pressurized with a fluid, so that the first bladder unit (112) becomes inflated and pushes the actuation plate (106) so as to move the valve pin (104) toward the valve-opened position.

6. The hot-runner system (100) of claim 5, wherein:
the first bladder unit (110) and the second bladder unit (112) include:
an arrangement of bladder units (110, 112), in which columns with rows of valve pins (104) are attached to the actuation plate (106), and the arrangement of bladder units (110, 112) are spaced between the valve pins (104).

7. An injection-molding system having the hot-runner system (100) of any one of claims 1 to 6.
